(19) United States
(12) Patent Application Publication
(10) Pub. No.: US 2025/0351907 A1
(43) Pub. Date: Nov. 20, 2025

(54) GLUE-FREE FALSE EYELASH PRODUCT PRODUCED BY ULTRASONIC WELDING AND MANUFACTURING METHOD THEREFORE

(71) Applicant: Qingdao Futesen Plastic Technology Co., Ltd, QINGDAO (CN)

(72) Inventors: Kexiu LI, QINGDAO (CN); Zhaozhong ZHANG, QINGDAO (CN)

(21) Appl. No.: 18/679,291

(22) Filed: May 30, 2024

(30) Foreign Application Priority Data
May 14, 2024 (CN) 202410596438.4

(51) Int. Cl. A41G 5/02

(52) U.S. Cl. CPC A41G 5/02

(57) ABSTRACT

A glue-free false eyelash product produced by ultrasonic welding and a manufacturing method are provided. The glue-free false eyelash product produced by ultrasonic welding includes eyelashes and an auxiliary film, the eyelashes are bonded on the auxiliary film by ultrasonic welding. The glue-free false eyelash product has enhanced toughness and soft texture, and it is not easy to break. The glue-free false eyelash product is convenient and quick to stick, and it is comfortable to wear, solving the problems that existed on wearing and using.

### CROSS REFERENCE TO RELATED DISCLOSURES

This disclosure claims foreign priority of Chinese Patent disclosure No. 202410596438.4, filed on May 14, 2024 in the China National Intellectual Property Administration, the disclosures of all of which are hereby incorporated by reference.

### TECHNICAL FIELD

The present disclosure relates to the technical field of makeup products technology, in particular to a glue-free false eyelash product produced by ultrasonic welding and manufacturing method therefore.

### BACKGROUND

In recent years, because of the convenient and beautiful characteristics, the false eyelash products are become more and more popular among women, and become an essential makeup products when women make up. But the existing false eyelashes are mostly made by two methods, one is to use thread and glue to bond the eyelashes, but glue is harmful to human body and long-term use will have certain impact on health; the other method is made of hot melting technology, and the false eyelashes products have the disadvantage of fragile and easily broken, which brings the inconvenience of use, and reduces the comfort of wearing.

### SUMMARY

The present disclosure provides a glue-free false eyelash product produced by ultrasonic welding and manufacturing method, to provide glue-free false eyelash product that is soft and convenient for using.

In an embodiment, the auxiliary film is made of polyester materials.

In another embodiment, a thickness of the auxiliary film is 0.001 mm to 1 mm, and a width of the auxiliary film is 0.1 mm to 100 mm.

In another embodiment, the auxiliary film is made by a wire drawing forming process, an extrusion process or a film blowing process.

To realize the above objective, the present disclosure provides a glue-free false eyelash product produced by ultrasonic welding, include eyelashes and an auxiliary film, roots of the eyelashes being bonded to the auxiliary film by ultrasonic welding including:

The present disclosure further provides a manufacturing method of a glue-free false eyelash product by ultrasonic welding, the manufacturing method of the glue-free false eyelash product by ultrasonic welding comprising following steps:
fixing an auxiliary film on a holding tool of an ultrasonic welding machine;
putting the eyelash piece on the auxiliary film, wherein a middle part of the eyelash piece is horizontal aligned with the auxiliary film;
pressing down the welding head of the ultrasonic welding machine until it contacts with the eyelash silk piece, applying welding pressure and ultrasonic vibration, bonding the eyelash piece to the auxiliary film, and obtaining the glue-free false eyelash product.

In another embodiment, before the step of fixing an auxiliary film on a holding tool of an ultrasonic welding machine, it also includes the following step:
preparing the eyelash piece by using an adhesive tape to bond eyelashes into shape, one side of the adhesive tape is the glue-free false eyelash product and another side is eyelash waste material.

In another embodiment, before the step of fixing an auxiliary film on a holding tool of an ultrasonic welding machine, it also includes the following step:
preparing the auxiliary film, the auxiliary film is made by drawing molding process, extrusion process or film blowing process; and the auxiliary film is made of polyester material.

In another embodiment, the auxiliary film has a thickness of 0.001 mm to 1 mm and a width of 0.1 mm to 100 mm.

In another embodiment, a location of the auxiliary film is coincided with a location of the adhesive tape.

In another embodiment, the step of bonding the eyelash piece to the auxiliary film, and obtaining the glue-free false eyelash product includes:
bonding the eyelash piece to the auxiliary film by heat generated by ultrasonic welding, the heat melt and adhere the auxiliary film onto the eyelash piece, and obtaining semi-finished product, the semi-finished product includes the glue-free false eyelash product and an eyelash waste;
cutting the semi finished product, keeping the glue-free false eyelash product, and abandoning the eyelash waste.

The present disclosure further provides a manufacturing method of a glue-free false eyelash product by ultrasonic welding, the manufacturing method of the glue-free false eyelash product by ultrasonic welding comprising following steps:
fixing a eyelash piece on a holding tool of an ultrasonic welding machine;
putting an auxiliary film on the eyelash piece, wherein a middle part of the eyelash piece is horizontal aligned with the auxiliary film;
pressing down the welding head of the ultrasonic welding machine until it contacts with the eyelash silk piece, applying welding pressure and ultrasonic vibration, bonding the eyelash piece to the auxiliary film, and obtaining the glue-free false eyelash product.

The embodiments of the present disclosure provide a glue-free false eyelash product by ultrasonic welding and the manufacturing method thereof, abandoned eyelash stems of the existing false eyelash product, and adopts an auxiliary film, and roots of the eyelashes are bonded to the auxiliary film by ultrasonic welding. The glue-free false eyelash product has enhanced toughness and soft texture, and it is not easy to break. The glue-free false eyelash product is convenient and quick to stick, and it is comfortable to wear, solving the problems that existed on wearing and using

### BRIEF DESCRIPTION OF THE DRAWINGS

FIG. 1 is a schematic structural diagram of a glue-free false eyelash product according to an embodiment of the present disclosure.

FIG. 2 is a schematic structural diagram of an eyelash piece according to an embodiment of the present disclosure.

FIG. 3 is a flow chart of a manufacturing method of the glue-free false eyelash product by ultrasonic welding according to an embodiment of the present disclosure.

FIG. 4 is a brief schematic structural diagram of an ultrasonic welding machine according to an embodiment of the present disclosure.

FIG. 5 is a flow chart of a manufacturing method of the glue-free false eyelash product by ultrasonic welding according to an embodiment of the present disclosure.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should be noted that when an element is described as “being fixed on” or “being arranged on” another element, the element may be directly arranged on the another element or there may be an intermediate element. When an element is described as “being connected to” another element, the element may be directly connected to the another element or there may be an intermediate element.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

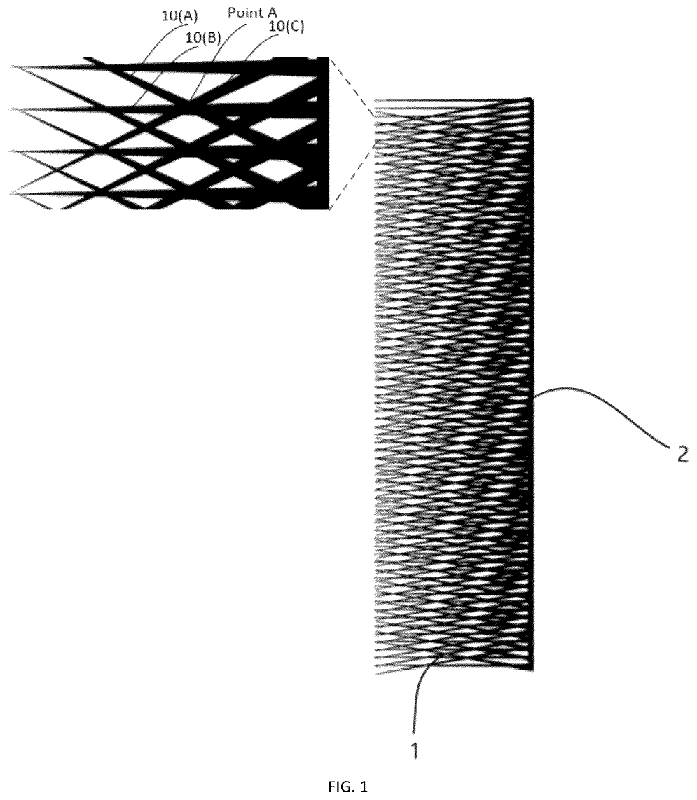

As shown in FIG. 1, FIG. 1 is a schematic structural diagram of a glue-free false eyelash product according to an embodiment of the present disclosure. The glue-free false eyelash product produced by ultrasonic welding includes eyelashes 1 and an auxiliary film 2, roots of the eyelashes 1 are bonded to the auxiliary 2 film by ultrasonic welding.

The auxiliary film 2 is made of polyester materials.

A thickness of the auxiliary film is 0.001 mm to 1 mm, and a width of the auxiliary film is 0.1 mm to 100 mm.

The auxiliary film is made by a wire drawing forming process, an extrusion process or a film blowing process.

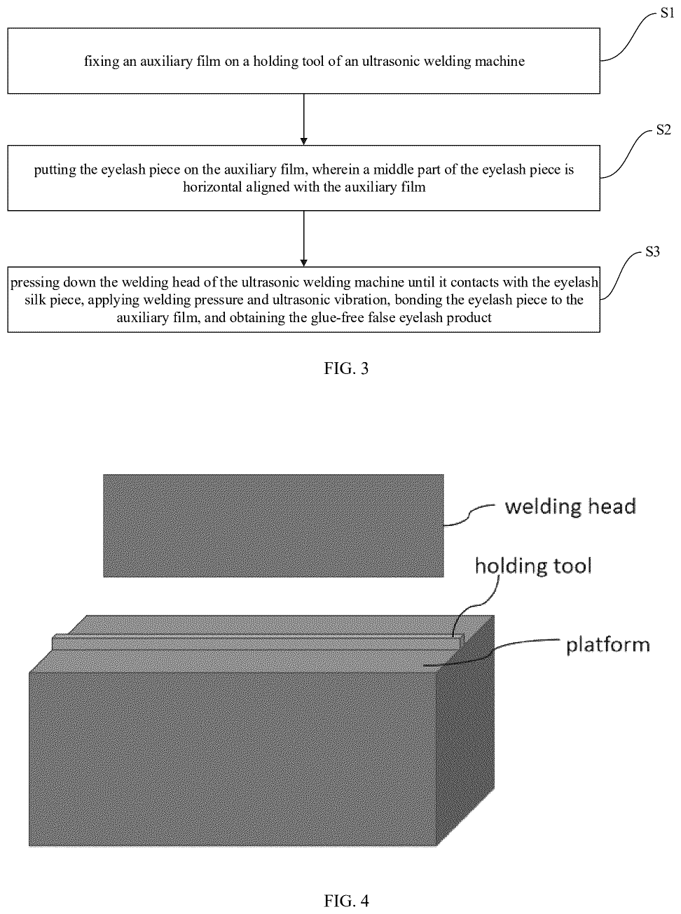

In an embodiment, the glue-free false eyelash product is produced by ultrasonic welding, as shown in FIG. 3, FIG. 3 is a flow chart of a manufacturing method of the glue-free false eyelash product by ultrasonic welding according to an embodiment of the present disclosure.

the manufacturing method of the glue-free false eyelash product by ultrasonic welding comprising following steps:

S1. fixing an auxiliary film on a holding tool of an ultrasonic welding machine;

Please refers to FIG. 4, FIG. 4 is a brief schematic structural diagram of an ultrasonic welding machine according to an embodiment of the present disclosure. The holding tool is fixed on a platform, a welding head is directly above the holding tool, and the welding tool is connected with an ultrasonic generator. In actually, the welding tool is lifted by a lifting device (not shown) and is able to move upward and downward, and the lifting device is fixed on the platform.

Before the step of S1, includes a step of preparing the eyelash piece by using an adhesive tape to bond eyelashes into shape, one side of the adhesive tape is the glue-free false eyelash product and another side is eyelash waste material.

And before the step of S1, includes a step of preparing the auxiliary film, the auxiliary film is made by drawing molding process, extrusion process or film blowing process; and the auxiliary film is made of polyester material. The auxiliary film has a thickness of 0.001 mm to 1 mm and a width of 0.1 mm to 100 mm.

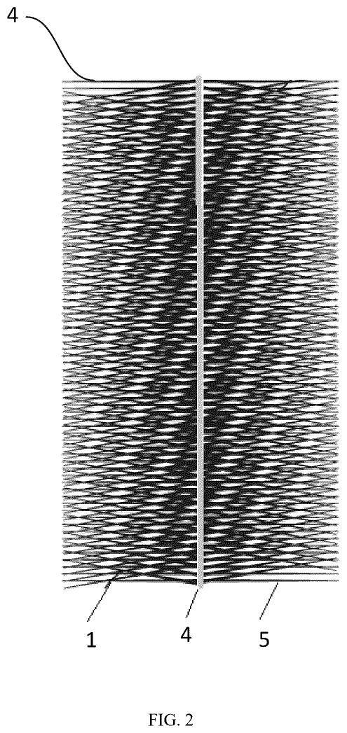

The eyelash piece 3 is shown in FIG. 2, using adhesive tape 4 to bond eyelash strands one by one into shape, after ultrasonic welding and cutting, to obtain the glue-free false eyelash product and eyelash waste material, that is, one side of the adhesive tape is the glue-free false eyelash product and another side is eyelash waste material 5.

S2. putting the eyelash piece on the auxiliary film, wherein a middle part of the eyelash piece is horizontal aligned with the auxiliary film; and a location of the auxiliary film is coincided with a location of the adhesive tape.

S3. pressing down the welding head of the ultrasonic welding machine until it contacts with the eyelash silk piece, applying welding pressure and ultrasonic vibration, bonding the eyelash piece to the auxiliary film, and obtaining the glue-free false eyelash product. Specifically, bonding the eyelash piece to the auxiliary film by heat generated by ultrasonic welding, the heat melt and adhere the auxiliary film onto the eyelash piece, and obtaining semi-finished product, the semi-finished product includes the glue-free false eyelash product and an eyelash waste; cutting the semi finished product, keeping the glue-free false eyelash product, and abandoning the eyelash waste.

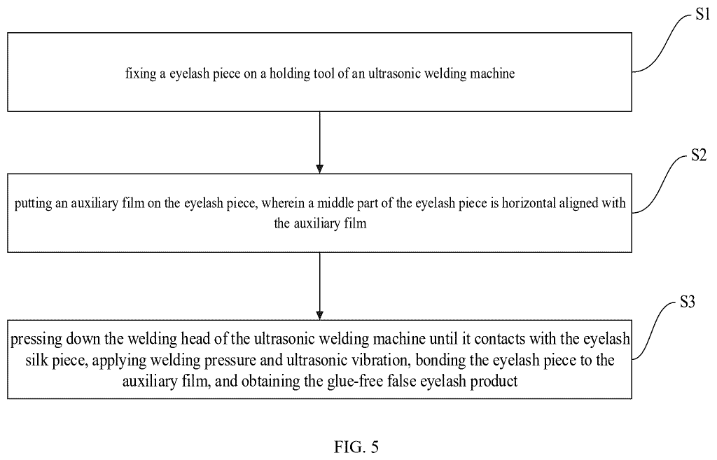

In another embodiment, the glue-free false eyelash product is produced by ultrasonic welding, as shown in FIG. 5, FIG. 5 is a flow chart of a manufacturing method of the glue-free false eyelash product by ultrasonic welding according to an embodiment of the present disclosure.

the manufacturing method of the glue-free false eyelash product by ultrasonic welding comprising following steps:

S1. fixing a eyelash piece on a holding tool of an ultrasonic welding machine;

Before the step of S1, includes a step of preparing the eyelash piece by using an adhesive tape to bond eyelashes into shape, one side of the adhesive tape is the glue-free false eyelash product and another side is eyelash waste material.

And before the step of S1, includes a step of preparing the auxiliary film, the auxiliary film is made by drawing molding process, extrusion process or film blowing process; and the auxiliary film is made of polyester material. The auxiliary film has a thickness of 0.001 mm to 1 mm and a width of 0.1 mm to 100 mm. A location of the auxiliary film is coincided with a location of the adhesive tape.

Please refers to FIG. 4, FIG. 4 is a brief schematic structural diagram of an ultrasonic welding machine according to an embodiment of the present disclosure. The holding tool is fixed on a platform, a welding head is directly above the holding tool, and the welding tool is connected with an ultrasonic generator. In actually, the welding tool is lifted by a lifting device (not shown) and is able to move upward and downward, and the lifting device is fixed on the platform.

S2. putting an auxiliary film on the eyelash piece, wherein a middle part of the eyelash piece is horizontal aligned with the auxiliary film;

S3. pressing down the welding head of the ultrasonic welding machine until it contacts with the eyelash silk piece, applying welding pressure and ultrasonic vibration, bonding the eyelash piece to the auxiliary film, and obtaining the glue-free false eyelash product.

the step of bonding the eyelash piece to the auxiliary film, and obtaining the glue-free false eyelash product includes:
bonding the eyelash piece to the auxiliary film by heat generated by ultrasonic welding, the heat melt and adhere the auxiliary film onto the eyelash piece, and obtaining semi-finished product, the semi-finished product includes the glue-free false eyelash product and an eyelash waste;
cutting the semi finished product, keeping the glue-free false eyelash product, and abandoning the eyelash waste.

The specific structure of the glue-free false eyelash product may refer to the foregoing embodiments. The glue-free false eyelash product adopts all the technical solutions of the foregoing embodiments, so it at least has all the technical effects brought by the technical solutions of the foregoing embodiments, which is not detailed herein.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

1. A glue-free false eyelash product produced by ultrasonic welding, comprising eyelashes and an auxiliary film, wherein the eyelashes comprise at least a first eyelash in a first direction, a second eyelash in a second direction, and a third eyelash in a third direction, wherein the first eyelash, the second eyelash, and the third eyelash cross over with each other, wherein each eyelashes comprise a first distal end having a first thickness and a second distal end having a second thickness greater than the first thickness, wherein the second distal end of the eyelashes is directly disposed on the auxiliary film by ultrasonic welding.

2. The glue-free false eyelash product produced by ultrasonic welding according to claim 1, wherein the auxiliary film is made of polyester materials.

3. The glue-free false eyelash product produced by ultrasonic welding according to claim 1, wherein a thickness of the auxiliary film is 0.001 mm to 1 mm, and a width of the auxiliary film is 0.1 mm to 100 mm.

4. The glue-free false eyelash product produced by ultrasonic welding according to claim 1, wherein the auxiliary film is made by a wire drawing forming process, an extrusion process or a film blowing process.

5. A manufacturing method of a glue-free false eyelash product by ultrasonic welding, wherein the manufacturing method of the glue-free false eyelash product by ultrasonic welding comprising following steps:
fixing an auxiliary film on a holding tool of an ultrasonic welding machine;
putting the eyelash piece on the auxiliary film, wherein a middle part of the eyelash piece is horizontal aligned with the auxiliary film;
pressing down the welding head of the ultrasonic welding machine until it contacts with the eyelash silk piece, applying welding pressure and ultrasonic vibration, bonding the eyelash piece to the auxiliary film, and obtaining the glue-free false eyelash product.

6. The manufacturing method of the glue-free false eyelash product by ultrasonic welding according claim 5, wherein before the step of fixing an auxiliary film on a holding tool of an ultrasonic welding machine, it also includes the following step:
preparing the eyelash piece by using an adhesive tape to bond eyelashes into shape, one side of the adhesive tape is the glue-free false eyelash product and another side is eyelash waste material.

7. The manufacturing method of the glue-free false eyelash product by ultrasonic welding according to claim 5, wherein before the step of fixing an auxiliary film on a holding tool of an ultrasonic welding machine, it also includes the following step:
preparing the auxiliary film, the auxiliary film is made by drawing molding process, extrusion process or film blowing process; and the auxiliary film is made of polyester material.

8. The manufacturing method of the glue-free false eyelash product by ultrasonic welding according to claim 7, wherein the auxiliary film has a thickness of 0.001 mm to 1 mm and a width of 0.1 mm to 100 mm.

9. The manufacturing method of the glue-free false eyelash product by ultrasonic welding according to claim 7, wherein a location of the auxiliary film is coincided with a location of the adhesive tape.

10. The manufacturing method of the glue-free false eyelash product by ultrasonic welding according to claim 5, wherein the step of bonding the eyelash piece to the auxiliary film, and obtaining the glue-free false eyelash product includes:
bonding the eyelash piece to the auxiliary film by heat generated by ultrasonic welding, the heat melt and adhere the auxiliary film onto the eyelash piece, and obtaining semi-finished product, the semi-finished product includes the glue-free false eyelash product and an eyelash waste;
cutting the semi finished product, keeping the glue-free false eyelash product, and abandoning the eyelash waste.

11. A manufacturing method of a glue-free false eyelash product by ultrasonic welding, wherein the manufacturing method of the glue-free false eyelash product by ultrasonic welding comprising following steps:
fixing a eyelash piece on a holding tool of an ultrasonic welding machine;
putting an auxiliary film on the eyelash piece, wherein a middle part of the eyelash piece is horizontal aligned with the auxiliary film;
pressing down the welding head of the ultrasonic welding machine until it contacts with the eyelash silk piece, applying welding pressure and ultrasonic vibration, bonding the eyelash piece to the auxiliary film, and obtaining the glue-free false eyelash product.

12. The manufacturing method of the glue-free false eyelash product by ultrasonic welding according claim 11, wherein before the step of fixing a eyelash piece on a holding tool of an ultrasonic welding machine:
preparing the eyelash piece by using an adhesive tape to bond eyelashes into shape, one side of the adhesive tape is the glue-free false eyelash product and another side is eyelash waste material.

13. The manufacturing method of the glue-free false eyelash product by ultrasonic welding according to claim 11, wherein before the step of fixing a eyelash piece on a holding tool of an ultrasonic welding machine, it also includes the following step:
preparing the auxiliary film, the auxiliary film is made by drawing molding process, extrusion process or film blowing process; and the auxiliary film is made of polyester material.

14. The manufacturing method of the glue-free false eyelash product by ultrasonic welding according to claim 13, wherein the auxiliary film has a thickness of 0.001 mm to 1 mm and a width of 0.1 mm to 100 mm.

15. The manufacturing method of the glue-free false eyelash product by ultrasonic welding according to claim 13, wherein a location of the auxiliary film is coincided with a location of the adhesive tape.

16. The manufacturing method of the glue-free false eyelash product by ultrasonic welding according to claim 10, wherein the step of bonding the eyelash piece to the auxiliary film, and obtaining the glue-free false eyelash product includes:
bonding the eyelash piece to the auxiliary film by heat generated by ultrasonic welding, the heat melt and adhere the auxiliary film onto the eyelash piece, and obtaining semi-finished product, the semi-finished product includes the glue-free false eyelash product and an eyelash waste;
cutting the semi finished product, keeping the glue-free false eyelash product, and abandoning the eyelash waste.

17. A glue-free false eyelash product produced by ultrasonic welding, comprising eyelashes and an auxiliary film, wherein the eyelashes comprise at least a first eyelash in a first direction, a second eyelash in a second direction, and a third eyelash in a third direction, wherein the first eyelash, the second eyelash, and the third eyelash cross over with each other, roots of the eyelashes being directly bonded to the auxiliary film by ultrasonic welding without an eyelash stem, wherein the eyelashes are only disposed on one side of the auxiliary film away from user skin.

18. The glue-free false eyelash product produced by ultrasonic welding according to claim 17, wherein the auxiliary film is made of polyester materials.

19. The glue-free false eyelash product produced by ultrasonic welding according to claim 17, wherein a thickness of the auxiliary film is 0.001 mm to 1 mm, and a width of the auxiliary film is 0.1 mm to 100 mm.

20. The glue-free false eyelash product produced by ultrasonic welding according to claim 17, wherein the auxiliary film is made by a wire drawing forming process, an extrusion process or a film blowing process.
